(19) United States
(12) Patent Application Publication
(10) Pub. No.: US 2018/0239123 A1
(43) Pub. Date: Aug. 23, 2018

(54) THREE-DIMENSIONAL STEREO IMAGE DISPLAY DEVICE FOR SURGICAL MICROSCOPE

(71) Applicant: Visionnaire Medtech Co., Ltd., Changhua City (TW)

(72) Inventors: Ming-Chou Ku, Changhua County (TW); Kai-Che Liu, Changhua County (TW); Kun-Wei Lin, Changhua County (TW); Ivan Ku, Changhua County (TW); Shih-Chi Chan, Changhua County (TW); Tong-Wen Wang, Changhua County (TW); I-Chun Lee, Changhua County (TW); Siang-Cyun Wang, Changhua County (TW)

(21) Appl. No.: 15/440,536

(22) Filed: Feb. 23, 2017

(51) Int. Cl. G02B 21/36; G02B 21/00; H04N 13/00

(52) U.S. Cl. CPC G02B 21/368; G02B 21/0012; H04N 2213/002; G02B 21/361; H04N 13/0003; G02B 21/365

(57) ABSTRACT

A 3D stereo image display device for a surgical microscope is provided. The surgical microscope comprises a main body, a mechanical arm, and an operation assembly. The 3D stereo image display device has a shell, at least one objective lens, an image processing circuit and a screen. The at least one objective lens is mounted in the shell. The image processing circuit is mounted in the shell and is electrically connected to the at least one objective lens. The host computer has an image processor for converting images captured by the at least one objective lens into 3D stereo images. The screen is mounted on an outer surface of the shell and is electrically connected to the image processing circuit for displaying the 3D stereo images. Thus, the 3D stereo image display device is provided to prevent tiredness and improve applicability and convenience.

### BACKGROUND OF THE INVENTION

### 1. Field of the Invention

The present invention relates to a three-dimensional stereo image display device, especially to a three-dimensional stereo image display device for surgical microscopes.

### 2. Description of the Prior Arts

With the advance of technology, the medical technique has progressed significantly. Three-dimensional (hereinafter referred to as 3D) stereo image is one of the popular techniques and topics applicable to clinical surgery, and allows doctors to cut, resect or treat organs or tissues having complex and different thicknesses. 3D stereo image technology is really helpful to medical examination and treatment, and thereby the doctors can perform surgeries more easily and accurately, and the medical technique and quality are improved. Thus, there are many kinds of surgical microscopes provided on the market.

The conventional surgical microscope (e.g. Lcica ULT 500) provides 3D stereo images to a doctor for surgery or treatment through disposing an objective lens assembly and at least two eyepiece assemblies on a mounting arm mounted on a front of a main body of the conventional surgical microscope. The objective lens assembly is used for capturing images of a human body or tissue, and each of the eyepiece assemblies connects to the objective lens assembly, so the user can watch the images captured by the objective lens assembly via the eyepiece assemblies. However, for a doctor who needs to watch the images via the eyepiece assemblies and perform a surgery for a long duration, muscles around the eyes that abut against the eyepiece assemblies may feel tired. Besides, the doctor's eyes have to depart from the eyepiece assemblies frequently during the surgery and stare at a surgical site of the human body for the surgery, so the eyes frequently move to abut and depart from the eyepiece assemblies, with both acts lasting for a long duration. In addition, the limited number of eyepiece assemblies cannot allow other medical staff to immediately observe the surgery process at the same time. Therefore, the applicability of the conventional surgical microscope is limited.

To overcome the shortcomings, the present invention provides a 3D display device for a surgical microscope to mitigate or obviate the aforementioned problems.

### SUMMARY OF THE INVENTION

The objective of the present invention is to overcome the shortcomings that the conventional surgical microscope can only observe images via eyepiece assemblies, which is inconvenient and makes the user feel tired easily, and that the conventional surgical microscope cannot allow a plurality of people to observe the surgery process because of the limited number of the eyepiece assemblies.

The main objective of the present invention is to provide a 3D stereo image display device for a surgical microscope that allows the users not to abut against the eyepiece assemblies, thereby being able to observe images at the surgical site, and allows a plurality of people to observe the captured images without the restriction of the number of the eyepiece assemblies. Thus, the present 3D stereo image display device for a surgical microscope can be used conveniently, decrease tiredness, and improve applicability.

The 3D stereo image display device is disposed with a surgical microscope, the surgical microscope comprises a main body having a host computer therein, a mechanical arm assembly joined with the main body, and an operation assembly joined with the mechanical arm assembly and electrically connected to the main body; the three-dimensional stereo image display device joined with the mechanical arm assembly and comprising:

a shell securely mounted on the mechanical arm assembly;

at least one objective lens mounted in the shell and facing downward;

an image processing circuit mounted in the shell and electrically connected to the at least one objective lens and the host computer; the image processing circuit comprising
an image processor electrically connected to the host computer for processing images captured by the at least one objective lens and converting the captured images into three-dimensional stereo images; and

a screen mounted on an outer surface of the shell and electrically connected to the image processing circuit for displaying the three-dimensional stereo images processed by the image processing circuit.

The aforesaid 3D stereo image display device, wherein the shell is a square hollow shell, and the shell comprises

a bottom;

an opening formed at the bottom of the shell;

wherein the at least one objective lens is mounted in the shell and positioned within a range of the opening.

The aforesaid 3D stereo image display device, wherein the at least one objective lens is two objective lenses mounted in the shell at a spaced interval from each other.

The aforesaid 3D stereo image display device, wherein each one of the at least one objective lens is a complementary metal-oxide-semiconductor lens.

The aforesaid 3D stereo image display device, wherein each one of the at least one objective lens is a charge-coupled device lens.

With aforesaid technique features, the present invention disposes a 3D stereo image display device on a surgical microscope and thereby images of an inspected part of the human body is processed and converted into 3D stereo images by the image processor of the image processing circuit and the 3D stereo images are immediately transmitted to the screen via the objective lens. Therefore, the present invention not only can help doctors to precisely locate lesions, nerves, or blood vessels, but also allow the doctors not to divert their sights from a treated site for watching the 3D stereo images during a surgery, which shortens the surgery duration and thereby relieves tiredness of eyes generated from abutting on the eyepiece assemblies for a long duration. Besides, the surgery will not be restricted by the number of eyepiece assemblies, which allows other medical staff to immediately observe the surgery process through the screen. Thus, the present invention provides a 3D stereo image display device for a surgical microscope to prevent tiredness and improve applicability and convenience.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a 3D stereo image display device for a surgical microscope in accordance with the present invention;

FIG. 2 is an exploded view of the 3D stereo image display device in FIG. 1;

FIG. 3 is a block diagram of the 3D stereo image display device in FIG. 1; and

FIG. 4 is an operational schematic view of the 3D stereo image display device in FIG. 1.

### DETAILED DESCRIPTION OF THE PREFERRED EMBODIMENTS

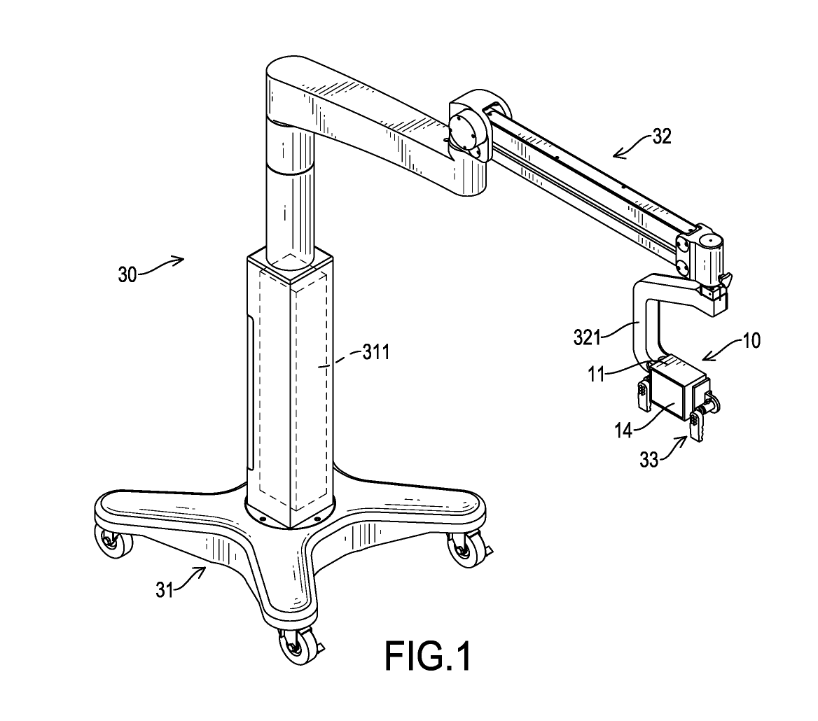

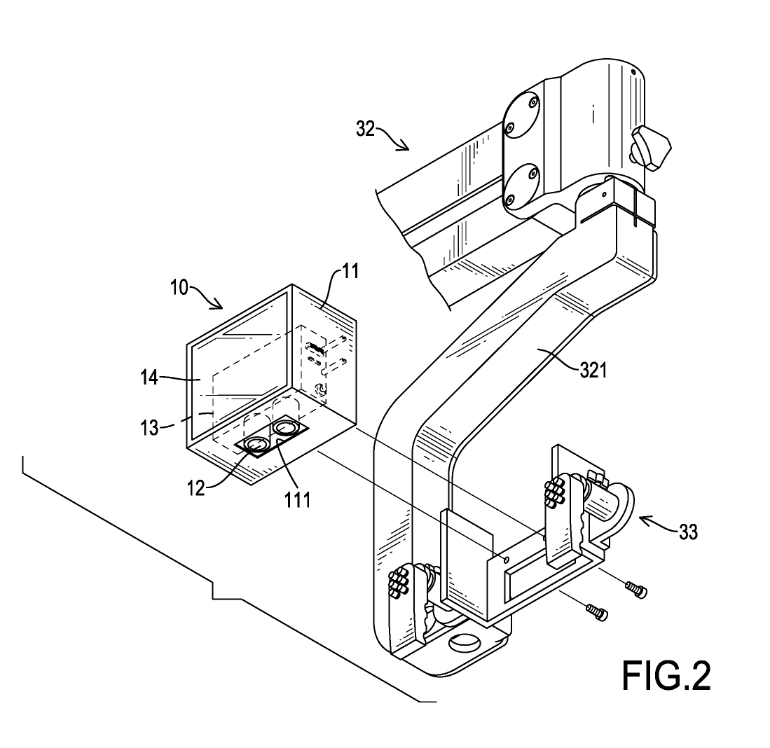

With reference to FIGS. 1 to 3, a three-dimensional (hereinafter referred to as 3D) stereo image display device 10 in accordance with the present invention is disposed with a surgical microscope 30. The surgical microscope 30 comprises a main body 31, a mechanical arm assembly 32 and an operation assembly 33. The main body 31 comprises a host computer 311 therein. The mechanical arm assembly 32 is joined to the main body 31 and comprises a rotation arm 321. The operation assembly 33 is joined to the mechanical arm assembly 32 and is electrically connected to the main body 31.

The 3D stereo image display device 10 is mounted to the mechanical arm assembly 32 of the surgical microscope 30 and comprises a shell 11, at least one objective lens 12, an image processing circuit 13 and a screen 14. The shell 11 is a square hollow shell securely mounted on the rotation arm 321 and comprises an opening 111 at a bottom of the shell 11. The at least one objective lens 12 is mounted in the shell 11, is positioned within a range of the opening 111, and faces downward. In a preferred embodiment, the 3D stereo image display device 10 comprises two separate objective lenses 12 at a spaced interval, and each one of objective lenses 12 is a CMOS lens (i.e. complementary metal-oxide-semiconductor lens) or a CCD lens (i.e. charge-coupled device lens). The image processing circuit 13 is mounted in the shell 11 and is electrically connected to the at least one objective lens 12 and the host computer 311. The image processing circuit 13 comprises an image processor therein, and the image processor is electrically connected to the host computer 311 for processing images captured by the at least one objective lens 12 and converting the captured images into 3D stereo images. The screen 14 is mounted on an outer surface of the shell 11 and is connected to the image processing circuit 13 for displaying the 3D stereo images processed by the image processor of the image processing circuit 13.

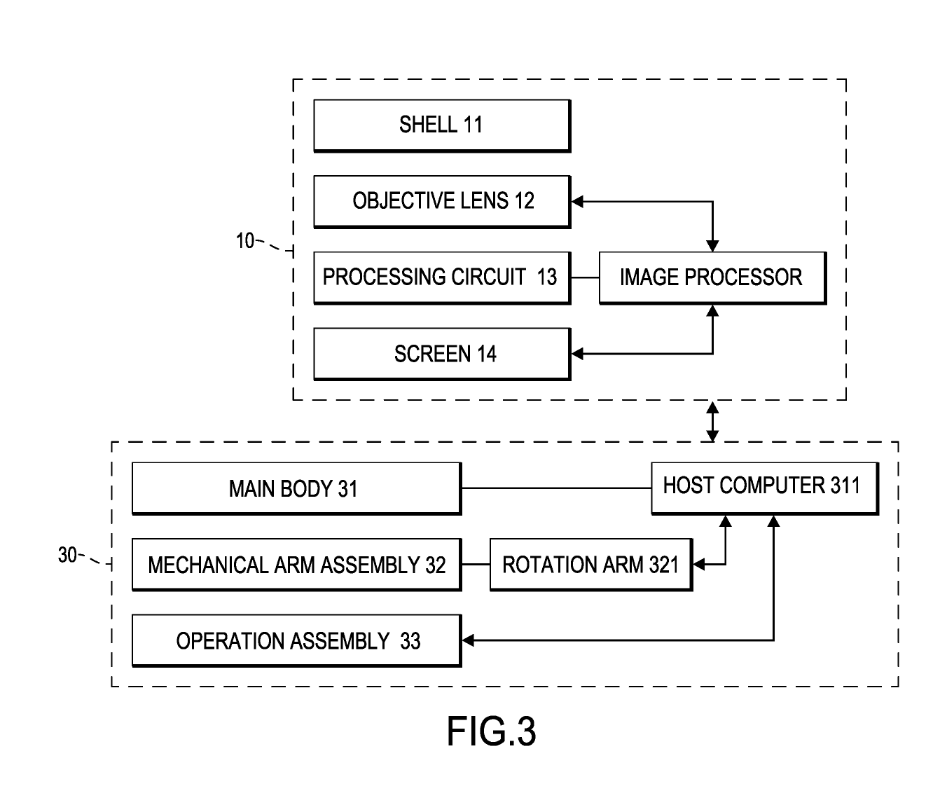

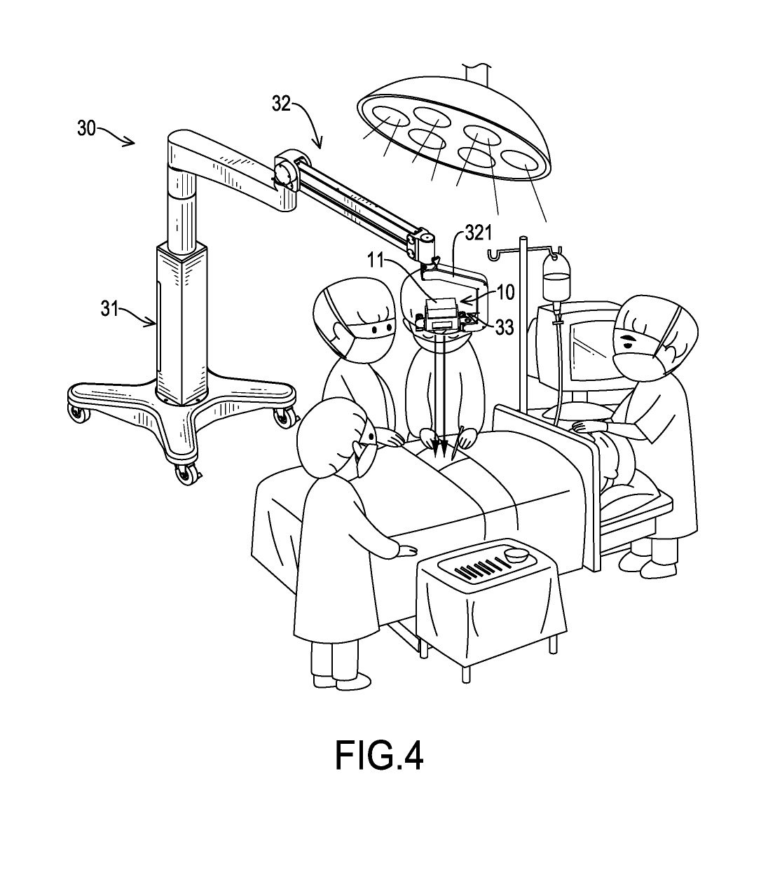

With reference to FIGS. 3 and 4, during a surgery or treatment to an organ or tissue of a human body through the surgical microscope 30, the main body 31 is moved to a position beside the human body and the at least one objective lens 12 of the 3D stereo image display device 10 is moved below the rotation arm 321 to a position above the human body. Then the operation assembly 33 is operated to capture images of an inspected site via the at least one objective lens 12. The captured images will be transmitted to the image processing circuit 13 and converted into 3D stereo images by the image processor. Then the converted 3D stereo images will be transmitted to the screen 14 such that doctors and other staff can clearly watch the 3D stereo images of the human organs or tissues through special 3D glasses, or, through autostereoscopy technology so that the doctors and staff can watch the 3D stereo images without 3D glasses. Therefore, the present invention allows doctors to watch the 3D stereo images without abutting their eyes against eyepiece assemblies, which relieves tiredness of muscles around the eyes caused by abutting against the eyepiece assemblies. The doctors no longer need to divert their sights from a wound for watching the 3D stereo images during a surgery and thereby the surgery duration is shortened. Besides, the surgery is no longer restricted by the number of eyepiece assemblies, which allows other medical staff to immediately observe the surgery process through the screen 14. Thus, the present invention improves the quality of surgery and the applicability and convenience of the surgical microscope 30.

Consequently, with aforesaid technical features, the present invention processes and converts 3D stereo images from images of an inspected part of the human body through the image process circuit of the image processing circuit 13, and immediately transmits the 3D stereo images to the screen 14 through the at least one objective lens 12. Therefore, the present invention not only can help doctors to locate lesions, nerves, or blood vessels, but also allows the doctors not to divert their sights from a wound for watching the 3D stereo images during a surgery, which shortens the surgery duration and relieves the tiredness caused by abutting eyepiece assemblies. Besides, the surgery will not be restricted by the number of eyepiece assemblies, which allows other medical staff to immediately observe the surgery process through the screen 14. Thus, the present invention provides a 3D stereo image display device for a surgical microscope to prevent tiredness and improve applicability and convenience.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A three-dimensional stereo image display device for a surgical microscope, wherein the surgical microscope comprises a main body having a host computer therein, a mechanical arm assembly joined with the main body, and an operation assembly joined with the mechanical arm assembly and electrically connected to the main body; the mechanical arm mounted between the main body and the operation assembly and comprising a rotation arm; the three-dimensional stereo image display device joined with the rotation arm of the mechanical arm assembly and comprising:
a shell securely mounted on the mechanical arm assembly;
at least one objective lens mounted in the shell and facing downward and controlled by the operation assembly for capturing images;
an image processing circuit mounted in the shell and electrically connected to the at least one objective lens and the host computer; the image processing circuit comprising
an image processor electrically connected to the host computer for processing the images captured by the at least one objective lens and converting the captured images into three-dimensional stereo images; and
a screen mounted on an outer surface of the shell and electrically connected to the image processing circuit for displaying the three-dimensional stereo images processed by the image processing circuit.

2. The three-dimensional stereo image display device for a surgical microscope as claimed in claim 1, wherein the shell is a square hollow shell, and the shell comprises:
a bottom;
an opening formed at the bottom of the shell;
wherein the at least one objective lens is mounted in the shell and positioned within a range of the opening.

3. The three-dimensional stereo image display device for a surgical microscope as claimed in claim 1, wherein the at least one objective lens is two objective lenses mounted in the shell and at a spaced interval from each other.

4. The three-dimensional stereo image display device for a surgical microscope as claimed in claim 2, wherein the at least one objective lens is two objective lenses mounted in the shell and at a spaced interval from each other.

5. The three-dimensional stereo image display device for a surgical microscope as claimed in claim 1, wherein each one of the at least one objective lens is a complementary metal-oxide-semiconductor lens.

6. The three-dimensional stereo image display device for a surgical microscope as claimed in claim 4, wherein each one of the at least one objective lens is a complementary metal-oxide-semiconductor lens.

7. The three-dimensional stereo image display device for a surgical microscope as claimed in claim 1, wherein each one of the at least one objective lens is a charge-coupled device lens.

8. The three-dimensional stereo image display device for a surgical microscope as claimed in claim 4, wherein each one of the at least one objective lens is a charge-coupled device lens.
